(19) United States
(12) Patent Application Publication
(10) Pub. No.: US 2019/0354056 A1
(43) Pub. Date: Nov. 21, 2019

(54) POST-PROCESSING APPARATUS, IMAGE FORMING APPARATUS, AND IMAGE FORMING SYSTEM

(71) Applicant: FUJI XEROX CO., LTD., Tokyo (JP)

(72) Inventors: Naoki HOMMA, Kanagawa (JP); Atsuya BABA, Kanagawa (JP)

(73) Assignee: FUJI XEROX CO., LTD., Tokyo (JP)

(21) Appl. No.: 16/351,543

(22) Filed: Mar. 13, 2019

(30) Foreign Application Priority Data
May 18, 2018 (JP) 2018-096103

(51) Int. Cl. G03G 15/00

(52) U.S. Cl. CPC G03G 15/607; G03G 15/602; G03G 2215/00721; G03G 15/5016; G03G 2215/00814; G03G 15/6573

(57) ABSTRACT

A post-processing apparatus includes a post-processing apparatus side detecting unit that detects a position of a paper sheet, in which in a case where it is determined by a determining unit that the paper sheet is to be cut, the determining unit determining whether or not to cut a paper sheet on which a transport failure straddling an image forming apparatus main body and a post-processing apparatus main body has occurred, based on at least one of an output of the post-processing apparatus side detecting unit or an output of an image forming apparatus side detecting unit included in an image forming apparatus, a presentation unit is allowed to make a presentation for promoting cutting of the paper sheet.

### CROSS-REFERENCE TO RELATED APPLICATIONS

This application is based on and claims priority under 35 USC 119 from Japanese Patent Application No. 2018-096103 filed May 18, 2018.

### BACKGROUND

### (i) Technical Field

The present invention relates to a post-processing apparatus, an image forming apparatus, and an image forming system.

### (ii) Related Art

In JP2001-233543A, there is disclosed an image forming apparatus including a paper sheet feeding unit for feeding paper sheets one by one from a bundle of paper sheets, a transport unit for transporting the paper sheet fed by the paper sheet feeding unit along a transport path, and an image forming unit for forming an image on the paper sheet transported by the transport unit, the image forming apparatus including: a paper sheet cutting unit for cutting the paper sheet in a case where the paper sheet is jammed on the transport path, in which the paper sheet cutting unit is provided at a predetermined position in the vicinity of the transport path to be movable along a direction in parallel with a plane including the paper sheet, which transports the transport path in a direction substantially perpendicular to a transport direction of the paper sheet.

In JP6131468B, there is disclosed an image forming system including a plurality of transport rollers along a paper sheet transport path, the image forming system including: at least one open cover provided capable of opening a part of a paper sheet transport path according to a user' s operation, a paper sheet determining unit for determining whether or not the paper sheet being transported has a long shape; a cover opening detecting unit for detecting that the open cover is open after a paper sheet transporting function is stopped during transport of the paper sheet; a control unit for driving a transport roller pinching the paper sheet such that the paper sheet at a position opened by the opening of the open cover may be slack, in a case where it is determined by the paper sheet determining unit that the paper sheet has a long shape, in which the control unit determines whether or not the user may pull and remove the paper sheet based on a determination result of the paper sheet determining unit, the control unit drives necessary transport rollers out of the plurality of transport rollers such that the paper sheet at the position opened by the opening of the open cover may be slack, in a case where it is determined that it is difficult to pull and remove the paper sheet, and the control unit further determines whether or not to pull out and remove the paper sheet, from how many transport rollers pinches the paper sheet and the basis weight of the paper sheet, based on a leading end position and a trailing end position of the paper sheet of which the transport is stopped.

### SUMMARY

A transport failure may occur on a paper sheet in a state of straddling an image forming apparatus main body and a post-processing apparatus main body. In order to remove the paper sheet on which the transport failure has occurred, in a case where the paper sheet on which the transport failure has occurred is cut in the state of straddling the image forming apparatus main body and the post-processing apparatus main body, the paper sheet remains in the post-processing apparatus main body, so there is a possibility that it becomes difficult to remove the paper sheet from the inside of the post-processing apparatus main body.

Aspects of non-limiting exemplary embodiments of the present disclosure relate to a post-processing apparatus, an image forming apparatus, and an image forming system that may make it difficult to generate a state in which it is difficult to remove the remaining paper sheet, as compared with a case where it is not determined whether or not cutting of the paper sheet is permitted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a post-processing apparatus including: a post-processing apparatus side detecting unit that detects a position of a paper sheet, in which in a case where it is determined by a determining unit that the paper sheet is to be cut, the determining unit determining whether or not to cut a paper sheet on which a transport failure straddling an image forming apparatus main body and a post-processing apparatus main body has occurred, based on at least one of an output of the post-processing apparatus side detecting unit or an output of an image forming apparatus side detecting unit included in an image forming apparatus, a presentation unit is allowed to make a presentation for promoting cutting of the paper sheet.

### BRIEF DESCRIPTION OF THE DRAWINGS

Exemplary embodiment(s) of the present invention will be described in detail based on the following figures, wherein:

FIG. 1 is a diagram showing an image forming system used in an exemplary embodiment of the present invention;

FIG. 2 is a diagram showing an image forming apparatus included in the image forming system shown in FIG. 1;

FIG. 3 is a diagram showing a post-processing apparatus included in the image forming system shown in FIG. 1;

FIG. 4 is a diagram showing the post-processing apparatus shown in FIG. 3 as viewed from a direction of an arrow A-A shown in FIG. 3;

FIG. 5 is a diagram showing a cutting apparatus included in the post-processing apparatus shown in FIG. 3;

FIG. 6 is a diagram showing a discharge mechanism included in the post-processing apparatus shown in FIG. 3;

FIG. 7 is a block diagram showing a control unit of the image forming system shown in FIG. 1;

FIGS. 8A to 8C show a paper sheet on which a transport failure has occurred in the image forming apparatus shown in FIG. 1, FIG. 8A is a diagram showing a paper sheet in a state where a leading end portion is not gripped by a gripping unit, FIG. 8B is a diagram showing a paper sheet in a state where a trailing end portion does not protrude from a folding apparatus main body, and FIG. 8C is a diagram showing a paper sheet in a state in which the leading end portion reaches the gripping unit and the trailing end portion protrudes from the folding apparatus main body;

FIG. 9 is a first flowchart for explaining operations in a case of presenting processing of the paper sheet on which the transport failure has occurred, in the image forming system shown in FIG. 1;

FIG. 10 is a second flowchart for explaining operations in a case of presenting the processing of the paper sheet on which the transport failure has occurred, in the image forming system shown in FIG. 1; and

FIG. 11 is a flowchart for explaining operations in a case of presenting the processing of the paper sheet on which the transport failure has occurred, in a modified example of the image forming system shown in FIG. 1.

### DETAILED DESCRIPTION

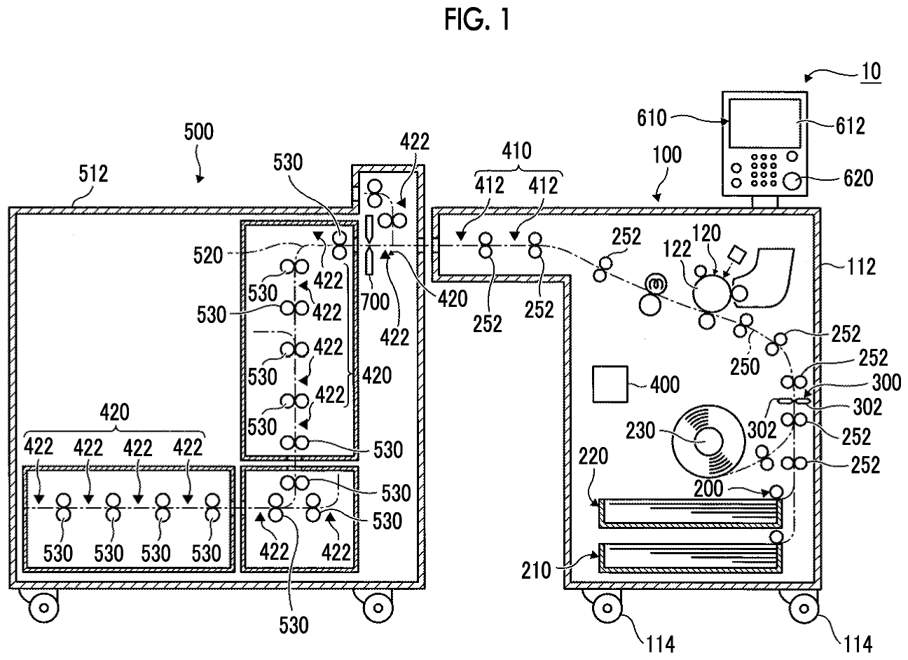

Next, an exemplary embodiment of the present invention will now be described with reference to the drawings. FIG. 1 is a sectional view showing an image forming system 10 used in the exemplary embodiment of the present invention from the left side surface. As shown in FIG. 1, the image forming system 10 includes an image forming apparatus 100 and a folding apparatus 500 that is an example of a post-processing apparatus. In the exemplary embodiment, the image forming apparatus 100 and the folding apparatus 500 are separate bodies and connectable to each other, and during normal use, the image forming apparatus 100 and the folding apparatus 500 are connected to each other.

The image forming apparatus 100 includes an image forming apparatus main body 112, and an image forming unit 120 for forming an image on a paper sheet is disposed within the image forming apparatus main body 112. The image forming unit 120 uses, for example, an electrophotographic method, includes a photoreceptor 122, transfers a toner image formed on the surface of the photoreceptor 122 to a paper sheet, and forms an image by fixing the toner image transferred onto the paper sheet to the paper sheet. Here, the paper sheet is an example of a recording medium on which an image is to be formed. The details of the image forming unit 120 will be described later.

A cutting apparatus 300 is further disposed within the image forming apparatus main body 112. The cutting apparatus 300 is a so-called automatic cutter including a circular blade 302, and a motor (not shown) moves the circular blade 302 to cut the paper sheet.

A paper sheet feeding apparatus 200 is further disposed within the image forming apparatus main body 112. The paper sheet feeding apparatus 200 is an apparatus for supplying paper sheets to the image forming unit 120, and includes a first supply unit 210, a second supply unit 220, and a third supply unit 230. The first supply unit 210 and the second supply unit 220 supply a cut paper sheet to the image forming unit 120, respectively. Here, the cut paper sheet is a paper sheet that is cut into a fixed form one by one, and also referred to as a cutform paper sheet. The third supply unit 230 supplies a rolled paper sheet toward the image forming unit 120 through the cutting apparatus 300. The rolled paper sheet that has been cut into optional-sized pieces by the cutting apparatus 300 is supplied to the image forming unit 120. Here, the rolled paper sheet is referred to as a paper sheet wound in a roll form.

A transport path 250 is formed within the image forming apparatus main body 112. The transport path 250 is used for transporting the paper sheet supplied from the paper sheet feeding apparatus 200 to the image forming unit 120 and is further used for transporting the paper sheet on which an image has been formed by the image forming unit 120 so as to be discharged to the outside of the image forming apparatus main body 112.

The image forming apparatus 100 further includes a paper sheet detecting unit 410. The paper sheet detecting unit 410 is an example of an image forming apparatus side detecting unit included in the image forming apparatus 100, and includes a plurality of sensors 412. Each of the plurality of sensors 412 is disposed along the transport path 250, and detects whether or not a paper sheet is present in the vicinity of the sensor 412.

The image forming apparatus 100 further includes a plurality of transport rolls 252. Each transport roll 252 is disposed along the transport path 250, and the transport rolls transport the paper sheet, respectively.

The image forming apparatus 100 further includes a caster 114. The caster 114 is an example of a movement assisting apparatus for assisting the movement of the image forming apparatus 100, and is mounted on the bottom surface of the image forming apparatus main body 112. As described above, since the image forming apparatus 100 is a body separate from the folding apparatus 500, in a case where a connection between the image forming apparatus 100 and the folding apparatus 500 is released, it is possible to move the image forming apparatus 100 separately from the folding apparatus 500 using the caster 114.

The folding apparatus 500 includes a folding apparatus main body 512, and a transport path 520 is formed within the folding apparatus main body 512. The transport path 520 is used for transporting a paper sheet discharged from the image forming apparatus main body 112 and inserted into the folding apparatus main body 512, and the paper sheet is bent and folded while being transported through the transport path 520.

The folding apparatus 500 further includes a paper sheet detecting unit 420. The paper sheet detecting unit 420 is an example of a post-processing apparatus side detecting unit and includes a plurality of sensors 422. Each of the sensors 422 is disposed along the transport path 520 and detects whether or not a paper sheet is present in the vicinity of the sensor 422.

The folding apparatus 500 further includes a plurality of transport rolls 530. Each of the transport rolls 530 is disposed along the transport path 520, and each transports the paper sheet.

The image forming system 10 further includes a presentation apparatus 610 and an operation apparatus 620. For example, the presentation apparatus 610 and the operation apparatus 620 are integrally configured and are mounted on, for example, the image forming apparatus main body 112 so as to be located outside the image forming apparatus main body 112.

The presentation apparatus 610 is an example of a presentation unit and includes a display apparatus 612 that may use, for example, a liquid crystal display panel or the like, and presents procedures for an operation to be performed next to the operator, for example. The operation apparatus 620 includes, for example, a power button to be pressed in a case where the power supply is turned, a numeric keypad for designating the number of paper sheets to be output, and the like.

In the exemplary embodiment, although there is used a configuration in which the presentation apparatus 610 is mounted on the image forming apparatus main body 112 and the image forming apparatus 100 includes the presentation apparatus 610, there maybe used another configuration in which the folding apparatus 500 includes the presentation apparatus 610. The presentation apparatus 610 may be configured as an external apparatus other than the image forming apparatus 100 and the folding apparatus 500. As the external apparatus used as the presentation apparatus 610, for example, a personal computer including a display apparatus may be mentioned.

The image forming system 10 further includes a control unit 400. The control unit 400 is disposed within the image forming apparatus main body 112, for example, controls each unit of the image forming apparatus 100 and controls the folding apparatus 500. In the exemplary embodiment, although there is used a configuration in which the control unit 400 is disposed within the image forming apparatus main body 112 and the image forming apparatus 100 includes the control unit 400, there may be used another configuration in which the folding apparatus 500 includes the control unit 400. There maybe also used a configuration in which an external apparatus such as a personal computer other than the image forming apparatus 100 and the folding apparatus 500 includes the control unit 400. The details of the control unit 400 will be described later.

The image forming system 10 further includes a cutting apparatus 700. The cutting apparatus 700 is an example of a cutting unit that cuts paper sheet, and disposed within the folding apparatus main body 512, for example. That is, in this exemplary embodiment, the folding apparatus 500 includes the cutting apparatus 700. In the exemplary embodiment, although there is used a configuration in which the folding apparatus 500 includes the cutting apparatus 700, there may be used another configuration in which the image forming apparatus 100 includes the cutting apparatus 700. The details of the cutting apparatus 700 will be described later.

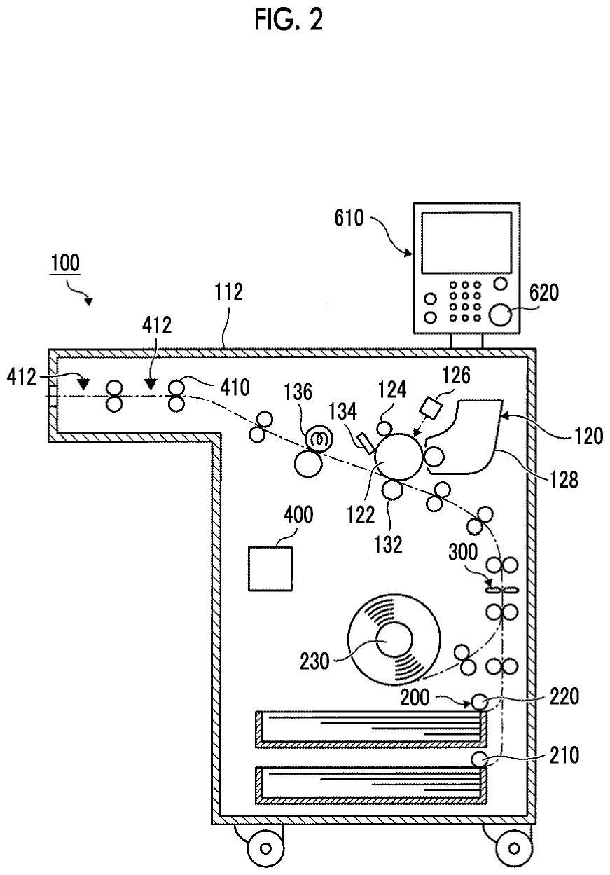

FIG. 2 shows the image forming apparatus 100. The image forming apparatus 100 includes the image forming unit 120 as described above. As described above, the image forming unit 120 includes a photoreceptor 122, and further includes an electrifying apparatus 124 that electrifies a surface of the photoreceptor 122, a latent image forming apparatus 126 that forms a latent image on the surface of the photoreceptor 122, a developing apparatus 128 that develops the latent image formed on the photoreceptor 122 with a developer containing a toner to form a toner image, a transfer apparatus 132 that transfers the toner image developed by the developing apparatus 128 onto a paper sheet, a cleaning apparatus 134 that cleans the surface of the photoreceptor 122, and a fixing apparatus 136 that fixes the toner image transferred onto the paper sheet by the transfer apparatus 132 to the paper sheet.

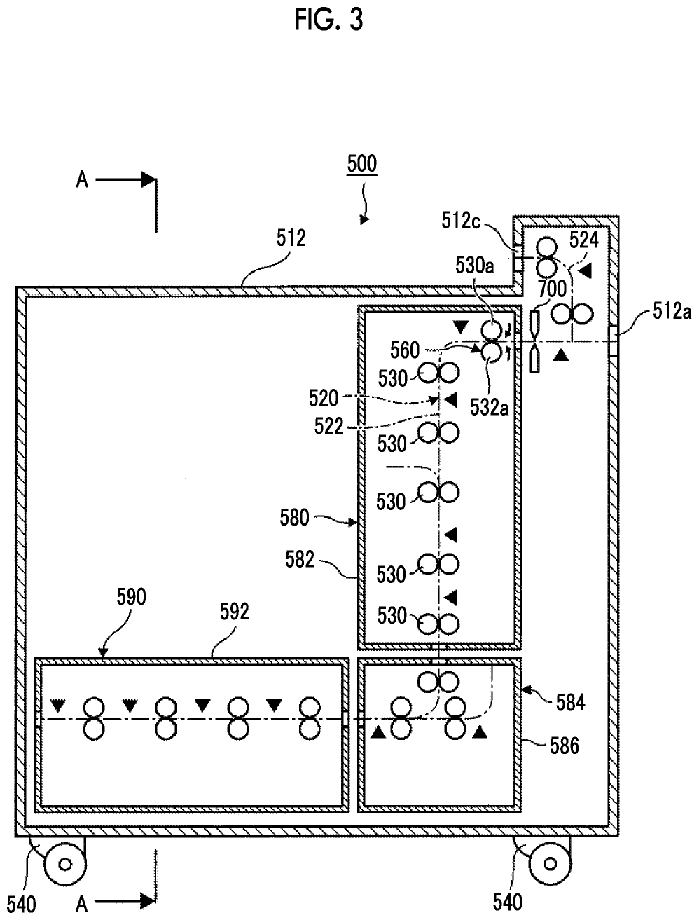

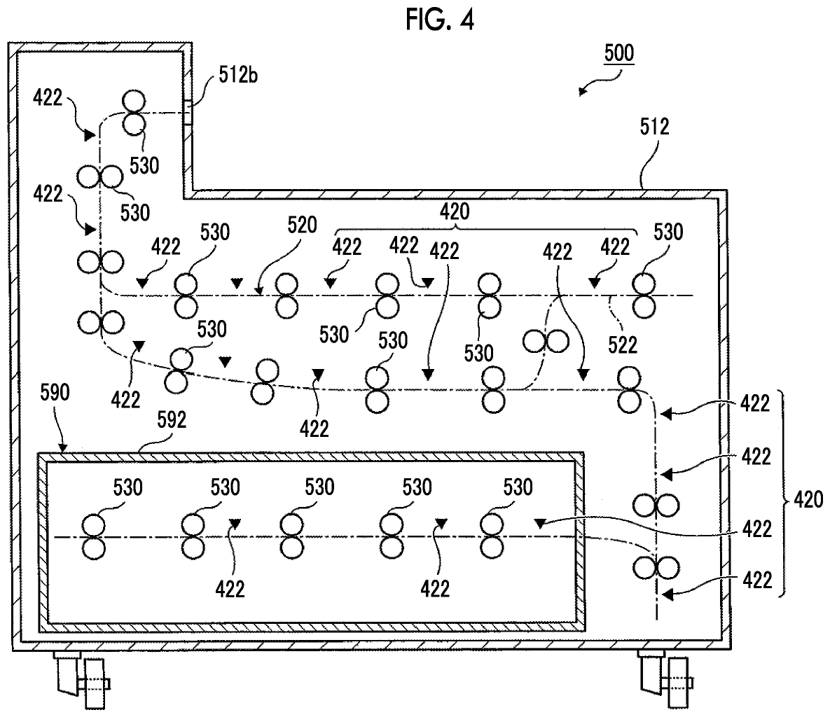

FIGS. 3 and 4 show the folding apparatus 500. As shown in FIGS. 3 and 4, the folding apparatus main body 512 is formed with an insertion opening 512a for inserting the paper sheet discharged from the image forming apparatus main body 112. The folding apparatus main body 512 is formed with a discharge opening 512b for discharging the paper sheet from inside the folding apparatus main body 512, and a discharge opening 512c for discharging the paper sheet from inside the folding apparatus main body 512, as well.

As described above, the transport path 520 is formed within the folding apparatus main body 512. As shown in FIGS. 3 and 4, the transport path 520 includes amain transport path 522 and a sub-transport path 524.

The main transport path 522 is a transport path for transporting the paper sheet inserted from the insertion opening 512a to the discharge opening 512b, and the paper sheet is bent and folded while being transported through the main transport path 522.

The sub-transport path 524 is a transport path for transporting the paper sheet to be discharged from the discharge opening 512c, and branches from the main transport path 522 at a position on a more upstream side than a first blade member 702 and a second blade member 704, as described later, in a paper sheet's transport direction of the main transport path 522. The paper sheet transported through the sub-transport path 524 is discharged to the outside of the folding apparatus main body 512 without being bent.

As described above, the folding apparatus 500 includes a plurality of transport rolls 530. Hereinafter, among these transport rolls 530, a transport roll 530 located at the most upstream side of the main transport path 522 in the transport direction of the paper sheet is referred to as a transport roll 530a. As shown in FIG. 3, in the vicinity of the transport roll 530a, a contact member 532a that is brought into contact with the transport roll 530a is disposed with the paper sheet interposed between the contact member 532a and the transport roll 530a. Here, the transport roll 530a and the contact member 532a are an example of a gripping unit that initially grips a paper sheet inserted into the folding apparatus main body 512 and transported through the main transport path 522.

The folding apparatus 500 further includes a pull-in mechanism 560. The pull-in mechanism 560 is a mechanism for pulling a paper sheet cut by the cutting apparatus 700 due to the occurrence of the transport failure in the folding apparatus main body 512, into an upper drawing unit 580. The details of the pull-in mechanism 560 will be described later.

The folding apparatus 500 further includes the upper drawing unit 580. The upper drawing unit 580 is an example of a first drawing unit and includes an upper drawing unit main body 582 and may be drawn out from the folding apparatus main body 512, for example, to the left side (the front side with respect to the paper sheet surface in FIG. 3). Among the plurality of transport rolls 530 described above, a transport roll disposed within the upper drawing unit main body 582 is an example of a first transport unit.

The folding apparatus 500 further includes a lower drawing unit 584. The lower drawing unit 584 is an example of a second drawing unit, includes a lower drawing unit main body 586, and may be drawn out to the left side, similarly to the upper drawing unit 580. The paper sheet that has discharged from the upper drawing unit 580 is transported into the lower drawing unit 584. Among the plurality of transport rolls 530 described above, a transport roll disposed within the lower drawing unit 584 is an example of a second transport unit.

As described above, the upper drawing unit 580 and the lower drawing unit 584 may be drawn out independently from the folding apparatus main body 512 and may be drawn out from the folding apparatus main body 512 in the identical direction. In some cases, a transport failure may occur on a paper sheet in a state of straddling the upper drawing unit 580 and the lower drawing unit 584. In such a case, in order to remove the paper sheet on which the transport failure has occurred, in a case where either the upper drawing unit 580 or the lower drawing unit 584 is drawn out, a paper sheet on which the transport failure is occurring will be broken, so there is a possibility that it becomes difficult to remove the paper sheet on which the transport failure is occurring. Therefore, in a case where the transport failure has occurred on a paper sheet in a state where the paper sheet straddles the upper drawing unit 580 and the lower drawing unit 584, it is desirable that the upper drawing unit 580 and the lower drawing unit 584 are simultaneously drawn out, for example.

The folding apparatus 500 further includes a rear drawing unit 590. The rear drawing unit 590 includes a rear drawing unit main body 592 and may be drawn out from the folding apparatus main body 512 to the rear side (the left side in FIG. 3).

The folding apparatus 500 further includes a caster 540. The caster 540 is an example of a movement assisting apparatus for assisting the movement of the folding apparatus 500, and is mounted on the bottom surface of the folding apparatus main body 512. As described above, since the folding apparatus 500 is a body separate from the image forming apparatus 100, in a case where the connection between the image forming apparatus 100 and the folding apparatus 500 is released, it is possible to move the folding apparatus 500 separately from the image forming apparatus 100 using the caster 540.

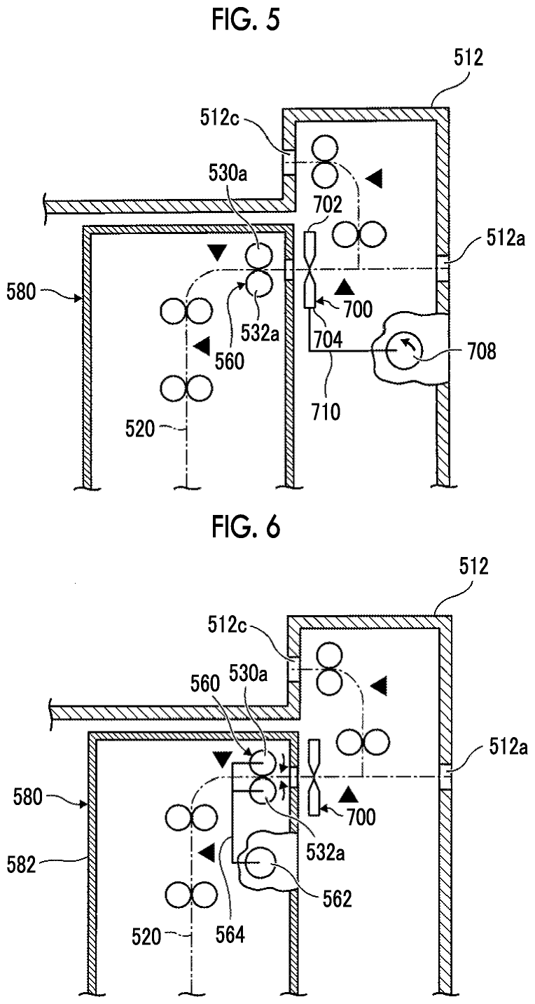

FIG. 5 shows a cutting apparatus 700. As shown in FIG. 5, the cutting apparatus 700 includes the first blade member 702 and the second blade member 704. The first blade member 702 is disposed, for example, above the transport path 520 such that the blade contacts the paper sheet in the transport path 520. The second blade member 704 is disposed on the side opposite to the first blade member 702 with respect to the transport path 520 such that the blade contacts the paper sheet in the transport path 520.

The cutting apparatus 700 further includes an operation unit 708. In a case where the paper sheet is cut by using the cutting apparatus 700, the operation unit 708 is operated by an operator, and the operation unit 708 is mounted on the left side surface of the folding apparatus main body 512. The operation unit 708 is connected to the first blade member 702 and the second blade member 704 by a connecting mechanism 710. As the connecting mechanism 710, for example, a gear train may be used.

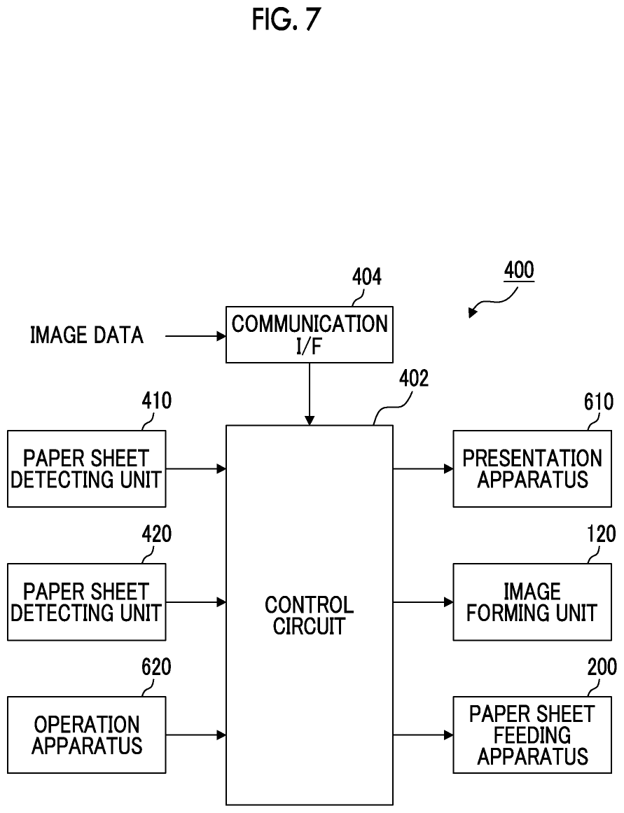

FIG. 6 shows a pull-in mechanism 560. As shown in FIG. 6, the pull-in mechanism 560 includes the transport roll 530a described above, and the contact member 532a described above, and further includes an operation unit 562.

The operation unit 562 to be rotatable is mounted on the left side surface of the upper drawing unit main body 582. The operation unit 562 is connected to the transport roll 530a and the contact member 532a by using a connecting mechanism 564. Here, for example, a gear train may be used as the connecting mechanism 564. Once the operator rotates the operation unit 562, the transport roll 530a and the contact member 532a rotate in the directions indicated by the arrows in FIG. 6, the paper sheet cut by the cutting apparatus 700 due to the occurrence of the transport failure is pulled into the upper drawing unit 580. The paper sheet that has been pulled into the upper drawing unit 580 is removed by the operator after the upper drawing unit 580 is drawn out to the left side (the front side with respect to the paper sheet surface in FIG. 3).

In the cutting apparatus 700 configured as described above, once the operator rotates the operation unit 708 in the direction of the arrow shown in FIG. 5, in a state where the respective blades are in contact with the paper sheet, the first blade member 702 and the second blade member 704 move from the right side (the inner side of the paper sheet surface in FIG. 5) to the left side (the front side of the paper sheet surface in FIG. 5) and cuts the paper sheet in the transport path 520.

In the image forming system 10 configured as described above, there is a possibility that the transport failure may occur on the paper sheet in a state of straddling the image forming apparatus 100 and the folding apparatus 500. In the case of removing a paper sheet on which the transport failure has occurred, in a state of straddling the image forming apparatus 100 and the folding apparatus 500, it is possible to cut the paper sheet by the cutting apparatus 700 and remove the paper sheet cut by the cutting apparatus 700 from the image forming apparatus 100 and the folding apparatus 500, respectively.

However, in a case where a paper sheet, on which the transport failure has occurred in a state of straddling the image forming apparatus 100 and the folding apparatus 500, is cut by the cutting apparatus 700, there is a possibility that it becomes difficult to remove the paper sheet on which the transport failure has occurred or it is impossible to remove the paper sheet on which the transport failure has occurred, depending on a position of the paper sheet on which the transport failure has occurred.

Therefore, in the image forming system 10, it is determined whether or not to cut the paper sheet on which the transport failure has occurred using the cutting apparatus 700, and in a case where it is determined that the paper sheet is to be cut, a presentation for promoting cutting of the paper sheet is made on presentation apparatus 610, and on the other hand, in a case where it is determined that the paper sheet is not to be cut, a presentation for promoting cutting of the paper sheet is not made. Hereinafter, more detailed description will be given.

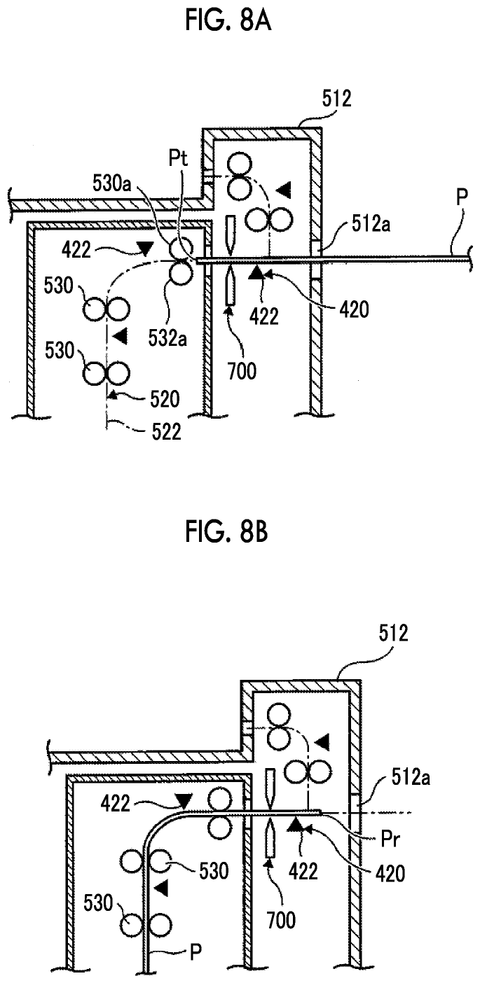

FIG. 7 is a block diagram illustrating the configuration of the control unit 400. As shown in FIG. 7, the control unit 400 includes a control circuit 402, and image data is input to the control circuit 402 through a communication interface 404. Outputs from the paper sheet detecting unit 410, that is, outputs from a plurality of sensors 412 and outputs from the paper sheet detecting unit 420, that is, outputs from a plurality of sensors 422 are input to the control circuit 402. An output from the operation apparatus 620 is input to the control circuit 402. The presentation apparatus 610, the image forming unit 120, and the paper sheet feeding apparatus 200 are controlled by the output from the control circuit 402.

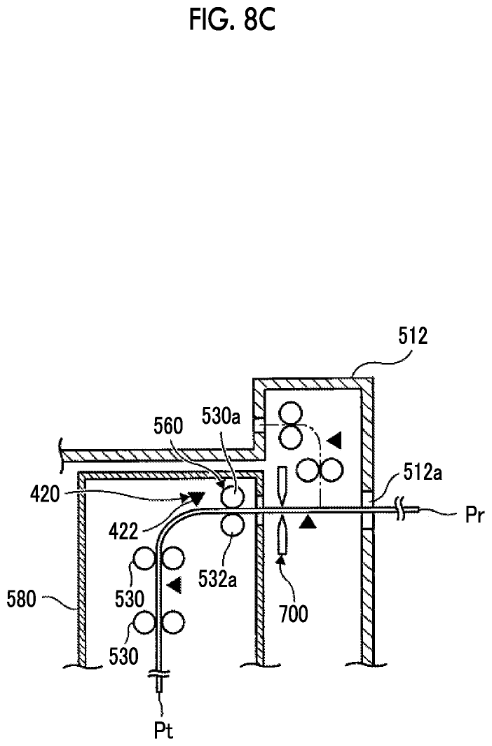

The control circuit 402 calculates a position of the paper sheet of being transported into the image forming system 10, from the output of the paper sheet detecting unit 410, that is, the output of the plurality of sensors 412 and the output of the paper sheet detecting unit 420, that is, the output of the plurality of sensors 422. Therefore, in a case where the transport failure has occurred on the paper sheet, the control circuit 402 may calculate a position of the leading end portion (a leading end portion Pt described later, see FIG. 8) of the paper sheet on which the transport failure has occurred, in the image forming system 10, and may calculate a position of the trailing end portion (a trailing end portion Pr described later, see FIG. 8) of the paper sheet on which the transport failure has occurred, in the image forming system 10.

The control circuit 402 determines whether or not to cut the paper sheet on which the transport failure has occurred, in a state of straddling the image forming apparatus main body 112 and the folding apparatus main body 512, by using the calculated positions of the paper sheet.

As described above, the control circuit 402 is an example of a determining unit that determines whether or not to cut the paper sheet.

FIGS. 8A to 8C are diagrams for explaining a paper sheet, on which the transport failure has occurred, in a state of straddling the image forming apparatus main body 112 and the folding apparatus main body 512. In the following description, the paper sheet may be set as a paper sheet P, the leading end portion of the paper sheet P may be set as the leading end portion Pt, and the trailing end portion of the paper sheet P may be set as the trailing end portion Pr.

FIG. 8A shows a paper sheet P on which a transport failure has occurred, in a state of straddling the image forming apparatus main body 112 and the folding apparatus main body 512, and the paper sheet P in a state where the leading end portion Pt does not reach the transport roll 530a and the contact member 532a. In a case where the paper sheet P is cut by the cutting apparatus 700 in the state shown in FIG. 8A, a portion on the leading end portion Pt side of the cut paper sheet P is not pinched by any of the plurality of transport rolls 530, which makes it difficult to move the paper sheet P within the folding apparatus main body 512, or makes it difficult to take out the paper sheet P from the folding apparatus main body 512.

Therefore, as shown in FIG. 8A, in a state in which the leading end portion Pt does not reach the transport roll 530a and the contact member 532a, it is desirable not to cut the paper sheet P with the cutting apparatus 700, for example. Therefore, in a case where the transport failure has occurred on the paper sheet P in the state shown in FIG. 8A, it is desirable not to make a presentation for promoting cutting of the paper sheet P on the presentation apparatus 610, for example.

FIG. 8B shows a paper sheet P on which transport failure has occurred, in a state of straddling the image forming apparatus main body 112 and the folding apparatus main body 512, and paper sheet P in which the trailing end portion Pr does not protrude from the folding apparatus main body 512. In a case where the paper sheet P is cut by the cutting apparatus 700 in the state shown in FIG. 8B, a portion on the trailing end portion Pr side of the cut paper sheet P is not pinched by any of the plurality of transport rolls 530, or it is difficult to move the paper sheet P within the folding apparatus main body 512. In the state shown in FIG. 8B, since the trailing end portion Pr side of the paper sheet P does not protrude from the folding apparatus main body 512, the operator may not draw out the paper sheet P from inside the folding apparatus main body 512, by grasping the trailing end portion Pr side of the cut paper sheet P from the outside of the folding apparatus main body 512.

That is, in a case where the paper sheet P is cut in the state shown in FIG. 8B, it becomes difficult to remove the trailing end portion Pr side of the paper sheet P from the folding apparatus main body 512. Therefore, as shown in FIG. 8B, in a state where the trailing end portion Pr does not protrude from the folding apparatus main body 512, it is desirable not to cut the paper sheet P by the cutting apparatus 700, for example. Therefore, in a case where the transport failure has occurred on the paper sheet P in the state shown in FIG. 8B, it is desirable not to make a presentation for promoting cutting of the paper sheet P on the presentation apparatus 610, for example.

FIG. 8C shows a paper sheet P on which the transport failure has occurred, in a state of straddling the image forming apparatus main body 112 and the folding apparatus main body 512, and paper sheet P in which the leading end portion Pt reaches the transport roll 530a and the contact member 532a and the trailing end portion Pr protrudes from the folding apparatus main body 512. In a case where the paper sheet P is cut in the state shown in FIG. 8C, the trailing end portion Pr side of the cut paper sheet P is to be drawn out from the folding apparatus main body 512 by the operator, by grasping a portion protruding from the outside of the folding apparatus main body 512 of the paper sheet P by the operator.

The portion on the leading end portion Pt side of the cut paper sheet P may be removed from the upper drawing unit 580 in a state where the upper drawing unit 580 is drawn out from the folding apparatus main body 512 after the operator operates the pull-in mechanism 560 so that the portion may be removed from inside the folding apparatus main body 512. Therefore, in the state shown in FIG. 8C, it is desirable to cut the paper sheet P using the cutting apparatus 700, for example. Therefore, in a case where the transport failure has occurred on the paper sheet P in the state shown in FIG. 8C, it is desirable to perform a display for promoting cutting of the paper sheet P on the presentation apparatus 610, for example.

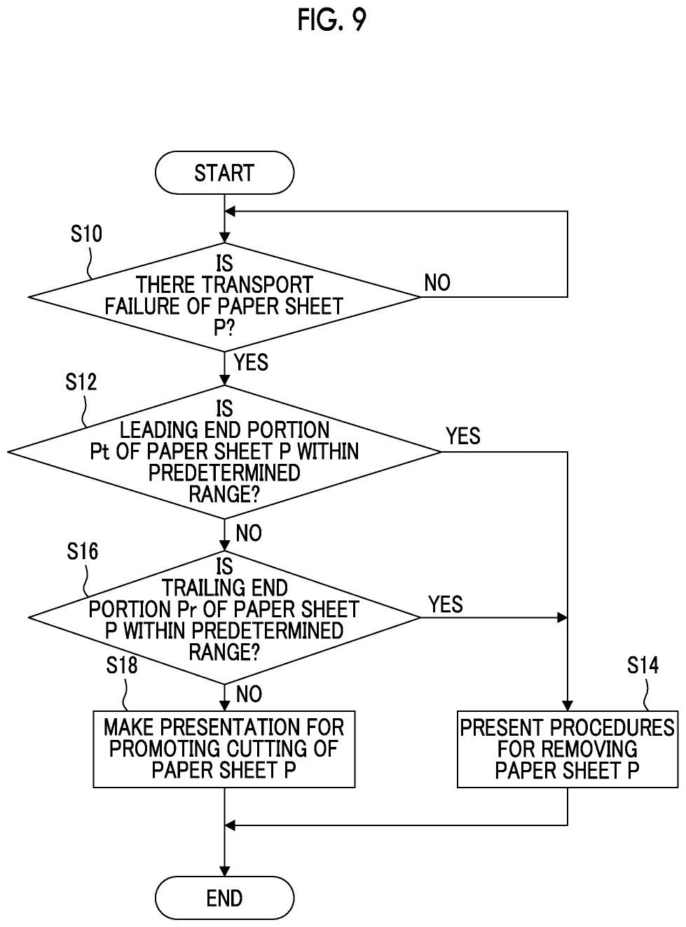

FIG. 9 is a first flowchart showing control of the presentation apparatus 610 by the control circuit 402. As shown in FIG. 9, once it is confirmed that a transport failure of the paper sheet has occurred in step S10 that is the first step, the control circuit 402 determines whether or not a position of the leading end portion Pt of the paper sheet P is within a predetermined range in step S12 that is the next step. That is, it is determined whether or not the leading end portion Pt of the paper sheet P is within the folding apparatus main body 512 and is located at a position where the leading end portion Pt does not reach the transport roll 530a and the contact member 532a.

In a case where it is determined in step S12 that the leading end portion Pt of the paper sheet P is within the folding apparatus main body 512 and is located at a position where the leading end portion Pt does not reach the transport roll 530a and the contact member 532a, the processing proceeds to step S14.

On the other hand, in a case where it is determined in step S12 that the leading end portion Pt of the paper sheet P reaches a position at which the transport roll 530a and the contact member 532a in the folding apparatus main body 512 are in contact with each other, the processing proceeds to step S16.

In step S16, it is determined whether or not a position of the trailing end portion Pr of the paper sheet P is within a predetermined range. That is, it is determined whether or not the trailing end portion Pr of the paper sheet P is located at a position where the trailing end portion Pr does not protrude from the folding apparatus main body 512.

In a case where it is determined in step S16 that the trailing end portion Pr of the paper sheet P is located at a position where the trailing end portion Pr does not protrude from the folding apparatus main body 512, the processing proceeds to step S14.

On the other hand, in a case where it is determined in step S16 that the trailing end portion Pr of the paper sheet P protrudes from the folding apparatus main body 512, the processing proceeds to step S18.

In step S14, the control circuit 402 performs control on the presentation apparatus 610 to allow the presentation apparatus 610 to present procedures for removing the paper sheet on which the transport failure has occurred. Here, the procedures for removing the paper sheet, which are presented on the presentation apparatus 610, do not include the step of cutting the paper sheet using the cutting apparatus 700. As an example of the presentation by the presentation apparatus 610 in step S14, for example, a display showing “please draw out the paper sheet from the folding apparatus”, or display showing “please pull the paper sheet into the folding apparatus by operating a dial (operation unit 562)” on the display apparatus 612 may be mentioned.

In step S18, the control circuit 402 performs control on the presentation apparatus 610 to allow the presentation apparatus 610 to make a presentation for promoting cutting of the paper sheet P.

Here, as an example of the presentation by the presentation apparatus 610, for example, performing a display showing “please cut the jammed paper sheet by rotating a dial (operation unit 708)” on the display apparatus 612 may be mentioned. As another example of a presentation by the presentation apparatus 610, a label describing a method of cutting paper sheet is pasted at any position of the image forming system 10, and performing a display showing “please cut the jammed paper sheet with reference to the label” on the display apparatus 612 may be mentioned.

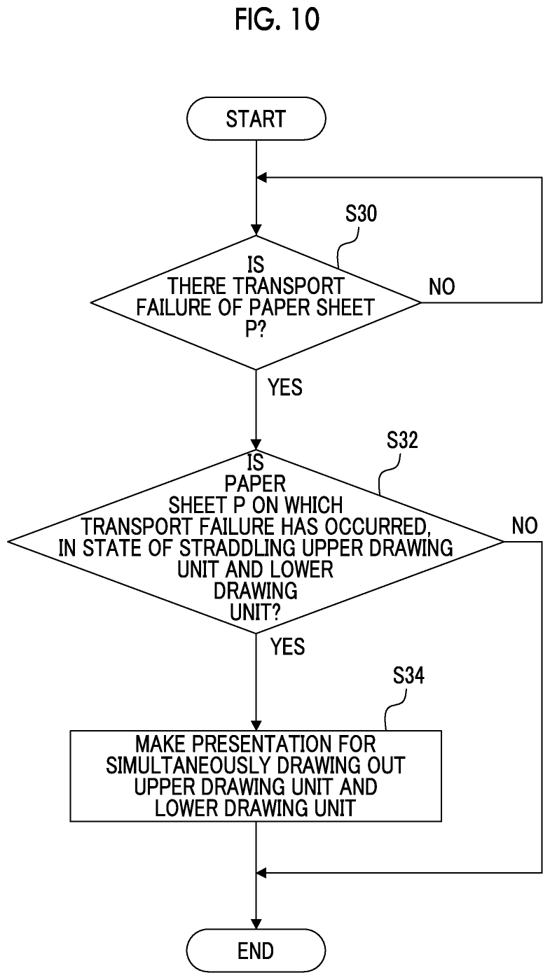

FIG. 10 is a second flowchart showing control of the presentation apparatus 610 by the control circuit 402. The control on the presentation apparatus 610, which will be described below, is performed, for example, after display promoting cutting of the paper sheet P in step S18 described above is performed.

As shown in FIG. 10, once it is confirmed in step S30 that is the first step, that a transport failure has occurred on the paper sheet, the control circuit 402 determines in step S32 that is the next step, whether or not the paper sheet on which the transport failure has occurred is in a state of straddling the upper drawing unit 580 and the lower drawing unit 584 based on the output of the sensor 422.

Once it is determined in step S32 that the paper sheet on which the transport failure has occurred is not in a state of straddling the upper drawing unit 580 and the lower drawing unit 584, the control circuit 402 ends the series of control. On the other hand, in a case where it is determined in step S32 that the paper sheet on which the transport failure has occurred is in a state of straddling the upper drawing unit 580 and the lower drawing unit 584, the processing proceeds to step S34.

In step S34, the control circuit 402 performs control on the presentation apparatus 610 to allow the presentation apparatus 610 to make a presentation for simultaneously drawing out the upper drawing unit 580 and the lower drawing unit 584. Here, as an example of the presentation by the presentation apparatus 610, for example, performing a display showing “please draw out the upper drawing unit and the lower drawing unit, simultaneously” on the display apparatus 612 may be mentioned.

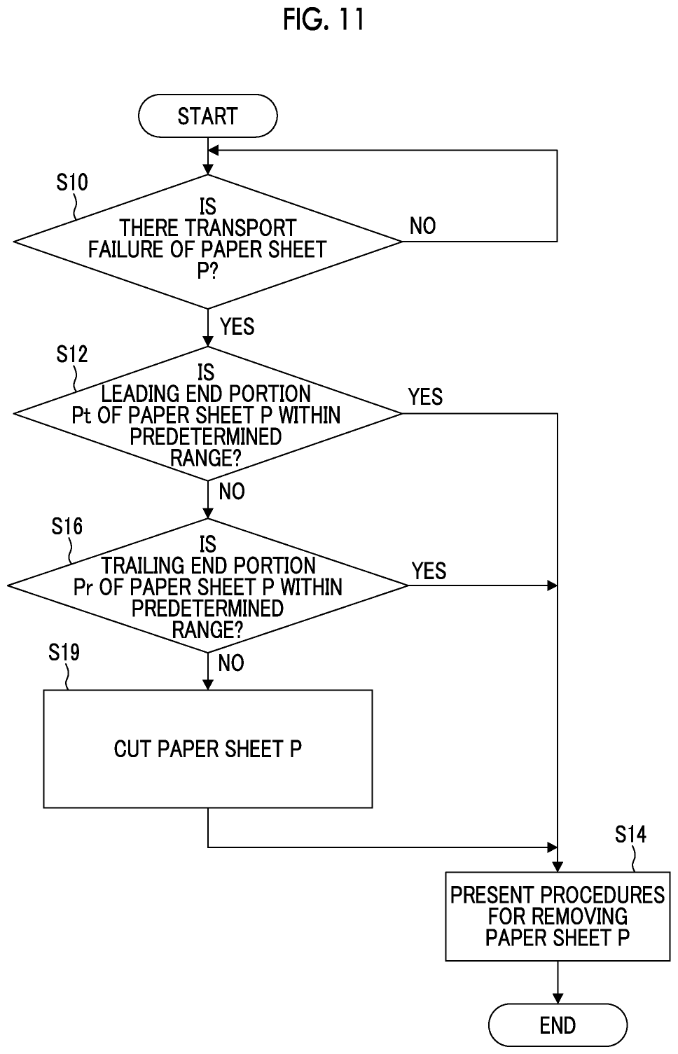

FIG. 11 is a flowchart showing control in a modified example of the present invention. In the exemplary embodiment described above, the cutting apparatus 700 is configured to cut the paper sheet P according to an operator's operation. On the contrary, in this modified example, the cutting apparatus 700 is configured to be driven by a driving source (not shown) such as a motor, thereby automatically cutting the paper sheet P.

Here, “automatic” that a specific operation by the operator is not required.

In the exemplary embodiment described above, in step S18, the control circuit 402 performs control on the presentation apparatus 610 to allow the presentation apparatus 610 to make a presentation to the operator for promoting cutting of the paper sheet P. On the contrary, in this modified example, in step S19 that is an alternative to step S18, the control circuit 402 performs control on the cutting apparatus 700 to allow the cutting apparatus 700 to cut the paper sheet P.

Then, after step S19, the processing proceeds to step S14, and in step S14, the control circuit 402 performs control on the presentation apparatus 610 to allow the presentation apparatus 610 to present procedures for removing the paper sheet on which the transport failure has occurred.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing apparatus comprising:
a post-processing apparatus side detecting unit that detects a position of a paper sheet,
wherein, in a case where it is determined by a determining unit that the paper sheet is to be cut, the determining unit determining whether or not to cut a paper sheet on which a transport failure straddling an image forming apparatus main body and a post-processing apparatus main body has occurred, based on at least one of an output of the post-processing apparatus side detecting unit or an output of an image forming apparatus side detecting unit included in an image forming apparatus, a presentation unit is allowed to make a presentation for promoting cutting of the paper sheet.

2. The post-processing apparatus according to claim 1,
wherein the presentation unit is provided.

3. The post-processing apparatus according to claim 1,
wherein the presentation unit included in the image forming apparatus is allowed to make the presentation for promoting cutting of the paper sheet.

4. The post-processing apparatus according to claim 1,
wherein the determining unit is provided.

5. The post-processing apparatus according to claim 2,
wherein the determining unit is provided.

6. The post-processing apparatus according to claim 3,
wherein the determining unit is provided.

7. The post-processing apparatus according to claim 1,
wherein the determining unit included in the image forming apparatus makes a determination.

8. The post-processing apparatus according to claim 2,
wherein the determining unit included in the image forming apparatus makes a determination.

9. The post-processing apparatus according to claim 1, further comprising:
a cutting unit that cuts the paper sheet.

10. The post-processing apparatus according to claim 1, further comprising:
a first drawing unit that includes a first transport unit which transports the paper sheet, and that is capable of drawing out the paper sheet from the post-processing apparatus main body; and
a second drawing unit that includes a second transport unit which transports the paper sheet, and that is capable of drawing out the paper sheet from the post-processing apparatus main body, the paper sheet being discharged from the first drawing unit and being transported into the second transport unit,
wherein a presentation for simultaneously drawing out the first drawing unit and the second drawing unit is made, in a case where the transport failure has occurred on the paper sheet in a state of straddling the first drawing unit and the second drawing unit.

11. An image forming apparatus comprising:
an image forming unit that forms an image on a paper sheet;
an image forming apparatus side detecting unit that detects a position of the paper sheet;
a determining unit that determines whether or not to cut a paper sheet on which a transport failure straddling an image forming apparatus main body and a post-processing apparatus main body has occurred, based on at least one of an output of a post-processing apparatus side detecting unit, for detecting a position of the paper sheet, included in a post-processing apparatus or an output of the image forming apparatus side detecting unit; and
a presentation unit that makes a presentation for promoting cutting of the paper sheet, in a case where it is determined by the determining unit that the paper sheet is to be cut.

12. The image forming apparatus according to claim 11,
wherein, in a case where it is determined by the determining unit that the paper sheet is not to be cut, the presentation unit presents procedures for removing the paper sheet.

13. The image forming apparatus according to claim 11,
wherein the determining unit determines that the paper sheet is not to be cut, in a case where a position of a leading end portion of the paper sheet on which the transport failure has occurred is within a predetermined range.

14. The image forming apparatus according to claim 13,
wherein the determining unit determines that the paper sheet is not to be cut, in a case where the leading end portion of the paper sheet has not reached a position at which the paper sheet is to be gripped by a gripping unit, which initially grips the paper sheet inserted into the post-processing apparatus main body, included in the post-processing apparatus.

15. The image forming apparatus according to claim 11,
wherein the determining unit determines that the paper sheet is to be cut, in a case where a trailing end portion of the paper sheet on which the transport failure has occurred is within a predetermined range.

16. The image forming apparatus according to claim 15,
wherein the determining unit determines that the paper sheet is not to be cut, in a case where the trailing end portion of the paper sheet does not protrude from the post-processing apparatus main body.

17. An image forming apparatus comprising:
an image forming unit that forms an image on a paper sheet,
an image forming apparatus side detecting unit that detects a position of the paper sheet;
a determining unit that determines whether or not to cut a paper sheet on which a transport failure straddling an image forming apparatus main body and a post-processing apparatus main body has occurred, based on at least one of an output of a post-processing apparatus side detecting unit, for detecting a position of the paper sheet, included in a post-processing apparatus or an output of the image forming apparatus side detecting unit; and
a presentation unit that presents procedures for removing the paper sheet after a cutting unit cuts the paper sheet, in a case where it is determined by the determining unit that the paper sheet is to be cut.
